(19) United States
(12) Patent Application Publication
(10) Pub. No.: US 2008/0164321 A1
(43) Pub. Date: Jul. 10, 2008

(54) SERIAL ATA CARD READER CONTROL SYSTEM AND CONTROLLING METHOD OF THE SAME

(75) Inventor: Sheng-yuan Lin, Taipei City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/780,062

(22) Filed: Jul. 19, 2007

(30) Foreign Application Priority Data
Jan. 10, 2007 (TW) 096101008

(51) Int. Cl. G06K 7/01

(52) U.S. Cl. 235/486

(57) ABSTRACT

The present invention discloses a serial ATA (SATA) card reader control system and a controlling method of the same. The SATA card reader control system and the controlling method are capable of identifying a flash memory card type which is intended to be accessed by an SATA host based on a 4-bit Port Multiplier port information defined in SATA Frame Information Structure (FIS). Accordingly, the SATA host with usage of only one physical transport can access at most fifteen different types of flash memory cards. And a SATA transmission interface can be utilized in a multi-card reader in order to access various types of flash memory cards and increase the transmission speed between the SATA host and the multi-card reader.

### TECHNICAL FIELD OF THE INVENTION

The present invention relates to a SATA (Serial Advanced Technology Attachment; SATA) card reader control system and the controlling method of the same, and more specifically in a device and a method for accessing various types of memory cards by using different addresses.

### BACKGROUND OF THE INVENTION

Nowadays, the consumptive demands on the huge transmissions and storages of digital videos, music, and documents are gradually increased due to an oncoming development of the digital consumption products and portable electronic products, such as digital cameras, mobile phones, MP3 (MPEGAudioLayer-3) players, PDA (Personal Digital Assistant) and the likes. Meanwhile, a flash memory card type provides several capabilities of non-volatilization, easily reading/writing, slight dimension and the convenience on portability, and thereby becomes as a storage component standardized for various types of portable electronic products.

Presently, there are several flash memory card type specifications which might includes a SD (Secure Digital) memory card, a Mini SD (Mini Secure Digital) memory card, a MMC (Multimedia) memory card, a CF (Compact Flash) memory card, a MS (Memory Stick) memory card and a SM (Smart Media) memory card. However, most of those flash memory card type specifications are incompatible with each other, and result in an inconvenience of when the consumers performs an access process thereamong. For this reason, a multiple card reader has been developed to access various types of memory cards in satisfaction with consumer demands.

A USB (Universal Serial Bus) card reader is one of multiple card readers with the most widespread use. Referring to FIG. 1, a primary architecture of the conventional access system for USB memory card is illustrated, which comprises a USB interface host 102, a USB card reader 106 and various types of flash memory cards, for example, including a CF memory card 112, a SM memory card 114, a SD memory card 116, a MS memory card 118 and the likes. The USB interface host 102 can transmit an instruction to the USB card reader 106. Based on said instruction from the USB interface host 102, the USB card reader 106 performs an access operation on which one flash memory card 112, 114, 116 and 118 is requested. Then, the USB card reader 106 transmits the accessed information back to the USB interface host 102. However, the highest access speed 480 Mbps (Mega-bits per second) provided by the USB interface is not enough in support of gradually-expanded storage volume for various types of flash memory cards. With the limitation in the access speed, the transmittal speed of the USB interface becomes a bottleneck of when the conventional host apparatus performs an access operation on the huge storage flash memory card.

Accordingly, a called SATA (Serial Advanced Technology Attachment) transmission interface has been developed with an access speed of up to 3 Gbps (Giga-bits per second) and a hot-plug function for high convenience on applications of those electric products. Referring to FIG. 2, a primary architecture of SATA transmission system is illustrated, which includes a SATA host 202 and a plurality of Hard Disk Drives (HDD) 212, 214, 216 and 218, wherein the SATA host 202 supports a specification of a SATA PM (Port Multiplier) 204 so as to accomplish a SATA PM port function. The SATA host 202 can utilize different SATA PM port information to command the various types of HDD for data access operations thereof. Since the SATA PM 204 meets a Frame Information Structure (FIS) defined in a SATA specification, the SATA host 202 with usage of only one physical transport port can utilizes a 4-bit PM port information defined in the SATA FIS to connect with at most fifteen SATA interface apparatuses (e.g. a SATA interface HDD etc.). Even though the conventional SATA transmission interface has an extremely-high transmission speed, the SATA transmission interface is developed for the HDD storage system, originally and can not be used directly in a multi-card reader to provide a proper solution for performing a high transmission speed.

As described above, it is essential to provide a SATA card reader control system and a controlling method of the same so as to meet the user demands on accesses to various types of flash memory cards and increase of the transmission speed between the host and the multi-card reader.

### SUMMERY OF THE INVENTION

In view of the problems and shortcomings of the prior art, a primary object of the present invention is to provide a SATA card reader control system and a controlling method of the same for accessing various types of memory cards by using different addresses.

To accomplish the above object, the present invention discloses a SATA card reader control system and a controlling method of the same. The SATA card reader control system includes a physical unit, a link unit, a transport unit and an application unit. The physical unit is used for providing a transformation and a linkage for SATA interface electrical signal. The link unit is used for decoding the signal transmitted from the physical unit and then generating a decode data, or for encoding a transmitted data and then transmitting the encoded data to the: physical unit. The transport unit is used for temporarily storing the decoded data transmitted from the link unit, and then generating a corresponding status control parameter. Furthermore, the transport unit would temporarily store the status control parameter into a status controlling register. The application unit includes a microcontroller, an operation register, a media hardware engine (MHE) and a data FIFO (First In First Out) register, wherein the microcontroller controls access operations on a flash memory card by reading a data from or writing a data to the status controlling register in the transport unit. In fact, the microcontroller can identify which type of the flash memory card is intended to be accessed according to a 4-bit Port Multiplier (PM) port information stored in the status control parameter. The operation register is used for storing various memory card control parameters and thereby controlling the memory card access operations based on the memory card control parameters. The media hardware engine is used for performing an access operation on the memory card based on the memory card control parameter. The data FIFO register is used for temporarily storing a data which is accessed from/to the memory card by the media hardware engine.

In accordance with the above controlling method of the SATA card reader control system, the invention further provides a controlling method herein, which comprises the following steps of:

step 1: transmitting an access instruction that contains a 4-bit Port Multiplier port information indicative of which one memory card type is intended to be accessed;

step 2: transforming the access instruction into a digital data;

step 3: decoding the digital data into a decoded data;

step 4: based on the 4-bit Port Multiplier port information contained in the decoded data, identifying which one memory card type should be accessed and then performing a corresponding access operation on the identified memory card type.

As described above, in the SATA card reader control system and the controlling method of the present invention, a 4-bit Port Multiplier port information defined in a SATA Frame Information Structure (FIS) is utilized to identify which one flash memory card type is intended to be accessed by the SATA host. Accordingly, the SATA host with usage of only one physical transport can access at most fifteen different types of flash memory cards. A SATA transmission interface can be applied within a multi-card reader to simultaneously access various types of flash memory cards and increase the transmission speed between the SATA host and the multi-card reader.

### BRIEF DESCRIPTION OF THE DRAWINGS

FIG. 1 is a diagram illustrating a primary architecture of a conventional USB access system;

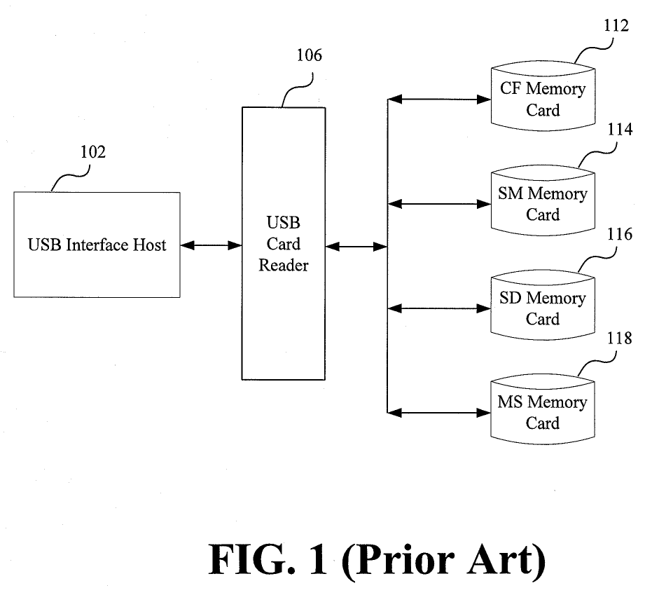

FIG. 2 is a schematic diagram illustrating a primary architecture of a conventional SATA transmission system;

FIG. 3 is a diagram illustrating a primary architecture of a SATA card reader control system according to a preferred embodiment of the present invention;

FIG. 4 is a functional block diagram illustrating a primary architecture of a SATA card reader chip according to the preferred embodiment of the present invention;

FIG. 5 is a flow chart illustrating a data reading controlling method for the SATA card reader control system according to the embodiment of the present invention; and

FIG. 6 is a flow chart illustrating a data writing controlling method for the SATA card reader control system according to the embodiment of the present invention.

### DETAILED DESCRIPTION OF THE INVENTION

An embodiment of the present invention will be explained in detail below.

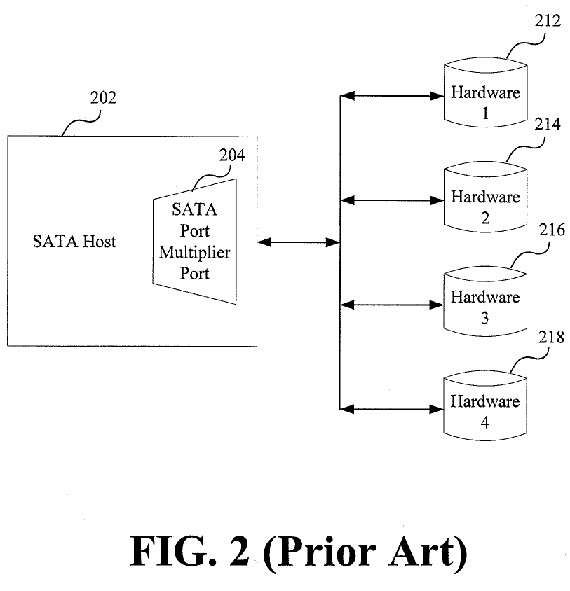

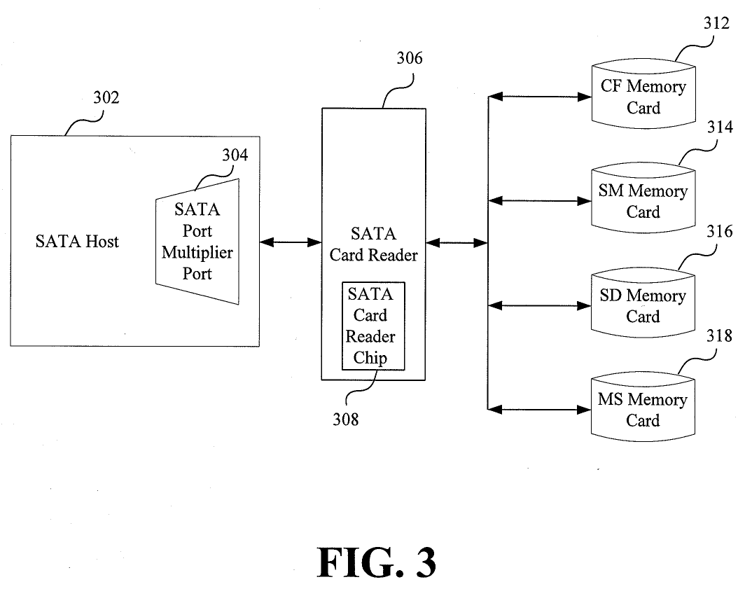

Firstly Referring to FIG. 3, a primary architecture of the SATA card reader control system in consistence with a SATA transmission interface specification is illustrated, which includes a SATA host 302, a SATA card reader 306 and various types of flash memory cards with different specifications, such as a CF memory card 312, a SM memory card 314, a SD memory card 316, a MS memory card 318 and the likes. However, data access of the SATA card reader control system according to the present invention should not be limited in the specific type cards illustrated in FIG. 3, and includes any other well-known specifications, such as a Mini SD (Mini Secure Digital) memory card and a MMC (Multimedia Card) memory card. The SATA host 302 can support a specification of a SATA PM (Port Multiplier) 304 to accomplish a capability of SATA PM port. While the SATA host 302 utilizes different SATA PM port information to transmit a SATA instruction, the SATA card reader 306 is informed of performing an access operation for the corresponding memory cards. Differently from the prior art depicted in FIG. 2, the SATA card reader control system according to the present invention further comprises a SATA card reader chip 308 for receiving an instruction transmitted from the SATA host 302 and performing an access operation on the corresponding memory card.

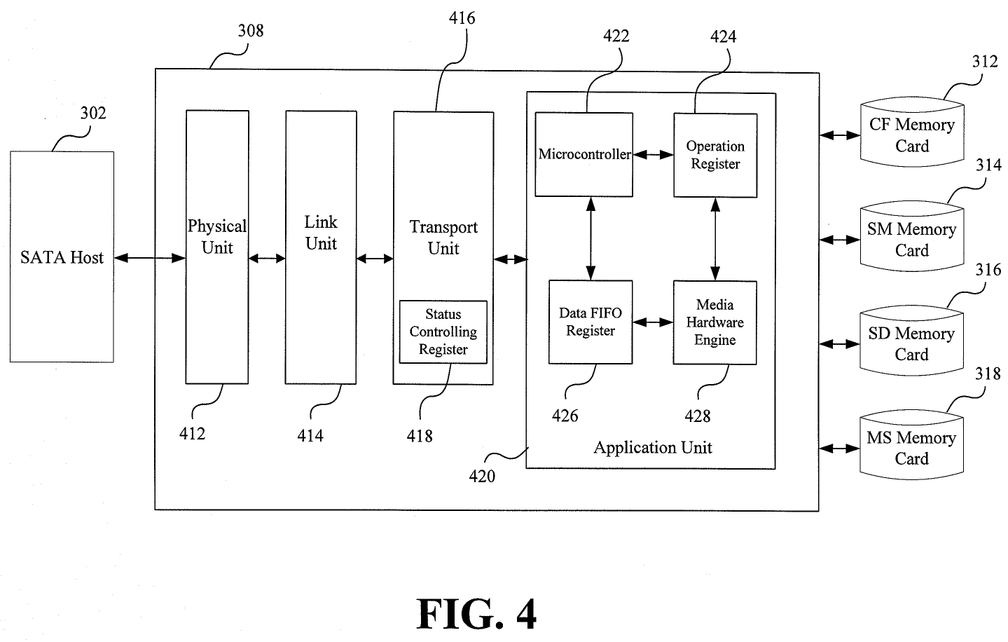

Referring to FIG. 4, a functional block diagram of the SATA card reader chip 308 is illustrated, which integrates a physical (PHY) unit 412, a link unit 414, a transport unit 416 and an application unit 420. Accordingly, the physical unit 412 is used for providing a transformation and a linkage for a SATA interface electrical signal. It means that the physical unit 412 can transform the electrical signal from the SATA transmission interface into a digital data, and then transmit the digital data to the link unit 414, or can transform the digital data transmitted from the link unit 414 into an electrical signal, and then transmit the electrical signal to the SATA host 302. The link unit 414 is used for providing several capabilities of decoding a received data and encoding a transmitted data, and thereby either decoding the signal or the data transmitted from the physical unit 412 and then transmitting the decoded data to the transport unit 416, or encoding a data which is transmitted from the transport unit 416 and then transmitting the encoded data to the physical unit 412. The transport unit 416 is used for providing a status control parameter to establish a host-to-slave linkage under the SATA interface, based on a Frame Information Structure (FIS) defined in a SATA specification. The transport unit 416 further comprises a status controlling register 418 for temporarily storing various status control parameters which can respectively establish several host-to-slave linkages in consistence with a SATA transmission interface specification so as to inform the application unit 420 of which one flash memory card type is intended to be accessed by the SATA host 302 and then performing which one corresponding access operation.

In addition, the application unit 420 includes a microcontroller 422, an operation register 424, a data FIFO (First In First Out) register 426 and a media hardware engine (MHE) 428. The microcontroller 422 can control the media hardware engine 428 to access a specific memory card by reading a data from or writing a data to the status controlling register 418, the operation register 424 and a data FIFO register 426 of the application unit 420. For this, the microcontroller 422 can control the entire operation for the SATA card reader chip 308.

When the SATA host 302 intends to read a specific memory card, the microcontroller 422 can identify a type of the specific memory card intended to be read and a reading operation corresponding to the card type, based on the status control parameter provided by the status controlling register 418 of the transport unit 416. Next, the microcontroller 422 controls the media hardware engine 428 to perform a read operation on the specific memory card based on a corresponding memory card control parameter defined within the operation register 424. Furthermore, the media hardware engine 428 stores the data read from the specific memory card into the data FIFO register 426 and then the microcontroller 422 transmits the data to the SATA host 302 via a SATA transmission interface. Oppositely, when the SATA host 302 intends to write a data in a specific memory card, the transport unit 416 temporarily stores the data to write into the data FIFO register 426. The microcontroller 422 can identify a type of the specific flash memory card intended to be written in and a writing operation corresponding to the type, based on a status control parameter provided by the status controlling register 418 of the transport unit 416. Next, the microcontroller 422 control the media hardware engine 428 to perform a writing operation on the specific memory card, based on a corresponding memory card control parameter defined within the operation register 424, wherein the media hardware engine 428 writes the data pre-stored in the data FIFO register 426 into the specific memory card. Please note that those memory card control parameters defined within the operation register 424 are used to control the media hardware engine 428 to perform access operations for various types of the memory cards, controlling a memory card power, detecting a memory card plugging status and controlling the card reader indicating lights. The media hardware engine 428 comprises different hardware engines for various types of the memory card so as to perform different access operations.

Substantially, the microcontroller 422 can identify which one type of the specific flash memory card is intended to be accessed by the SATA host 302, based on a 4-bit Port Multiplier port information defined in the status control parameter, so as to facilitate that the SATA host 302 with usage of only one physical transport can simultaneously access at most fifteen different types of flash memory cards. During a period that the SATA host 302 performs the access operation, the 4-bit Port Multiplier port information is treated as a status control parameter and stored within the status register 418 of the transport unit 416 for assisting the microcontroller 422 to identify which one type of the specific flash memory card is trended to be accessed and a corresponding access operation.

Since the SATA specification defines a Command-Based Switching mode, the microcontroller 422 can utilize the 4-bit PM port information to identify which one type of the specific flash memory card is trended to be accessed by the SATA host 302. The SATA host 302 with usage of only one physical transport can access at most fifteen different types of flash memory cards. The Command-Based Switching mode allows only one SATA apparatus to occupy a transmission bandwidth for the same time, but can decreases a chip cost of the SATA host.

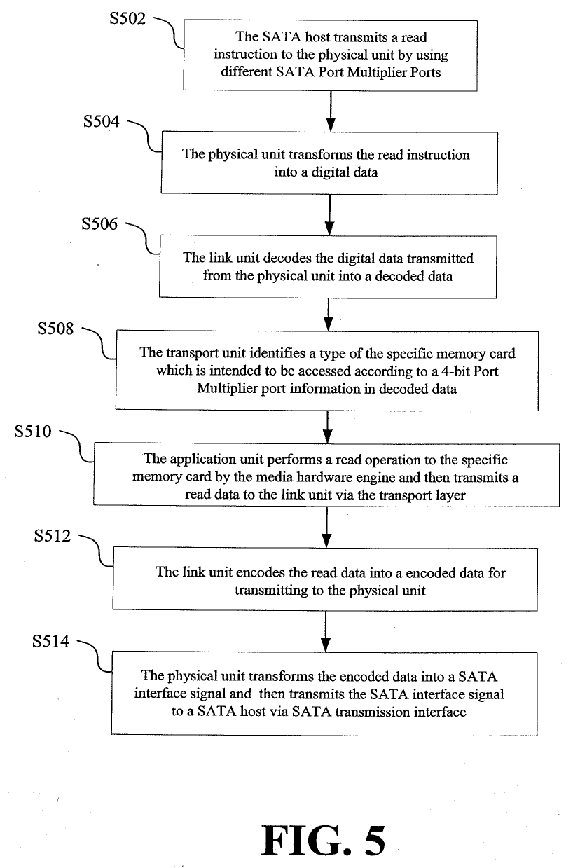

Referring to FIG. 5, a data reading controlling method applied for the SATA card reader control system according to FIG. 4 is illustrated for reading the data from a specific flash memory card. When the SATA host 302 performs a reading operation on the specific flash memory card, the SATA host 302 transmits a read instruction to the physical unit 412 by using different SATA Port Multiplier port information. The read instruction contains a 4-bit Port Multiplier port information indicative of which type of the specific flash memory card is intended to be read (as a step S502). The physical unit 412 transforms the read instruction received from the SATA transmission interface, via the SATA transmission interface, into a digital data which can be processed by the link unit 414, and then transmits the digital data to the link unit 414 (as a step S504). The link unit 414 decodes the digital data transmitted from the physical unit 412, and then generates a decoded data for being transmitted to the transport unit 416 (as a step S506). The 4-bit Port Multiplier port information contained in the decode data is stored as a status control parameter in the status controlling register 418 of the transport unit 416 so as to control the application unit 420 to perform a reading operation on the specific memory card (as a step S508). The microcontroller 422 of the application unit 420 analyzes the decoded data to identify the read instruction thereof, and then determines the specific flash memory card type is intended to be accessed and a access operation corresponding to the card type, based on the status control parameter (which contains a 4-bit Port Multiplier port information) of the status controlling register 418. Moreover, the microcontroller 422 of the application unit 420 also controls the media hardware engine 428 to perform the read operation on the specific flash memory card by using the memory card control parameter in the operation register 424. Then, the media hardware engine 428 stores the data read from the specific flash memory card into the data FIFO register 426. The microcontroller 422 transmits the read data pre-stored in the data FIFO register 426 to the link unit 414 via the transport unit 416 (as a step S510). The link unit 414 encodes the read data transmitted from the transport unit 416, and then generates an encoded data for transmitting the encoded data to the physical unit 412 (as a step S512). The physical unit 412 transforms the encoded data transmitted from the link unit 414 into a SATA interface signal, and then transmits the SATA interface signal to the SATA host 302 via the SATA transmission interface (as a step S514).

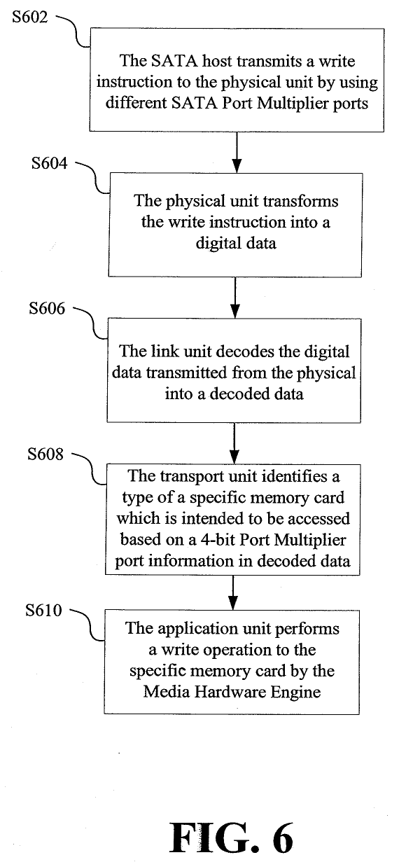

Referring to FIG. 6, a data writing controlling method applied for the SATA card reader control system according to FIG. 4 is illustrated for writing a data into a specific flash memory card. When the SATA host 302 performs a write operation on the specific flash memory card, the SATA host 302 transmits a write instruction to the physical unit 412 by using different SATA Port Multiplier port information, wherein the write instruction contains a 4-bit Port Multiplier port information. The 4-bit Port Multiplier port information indicates which type of the specific flash memory card is intended to be written in (as a step S602). The physical unit 412 transforms the write instruction received from the SATA transmission interface, via the SATA transmission interface, into a digital data which can be processed by the link unit 414, and then transmits the digital data to the link unit 414 (as a step S604). The link unit 414 decodes the digital data transmitted from the physical unit 412, and then generates a decoded data for being transmitted to the transport unit 416 (as a step S606). The 4-bit Port Multiplier port information contained in the decoded data is stored as a status control parameter in the status controlling register 418 of the transport unit 416 so as to control the application unit 420 to perform the write operation on the specific flash memory card (as a step S508). The microcontroller 422 of the application unit 420 analyzes the decoded data to identify the write instruction. Moreover, the microcontroller 422 of the application unit 420 also controls the media hardware engine 428 to perform the write operation on the specific flash memory card by using the memory card control parameter in the operation register 424. The media hardware engine 428 would write the written data per-stored within the data FIFO register 426 into the specific flash memory card (as a step S610).

In conclusion, the SATA card reader control system and the controlling method according to the present invention are capable of identifying a flash memory card type which is intended to be accessed by an SATA host, based on a 4-bit Port Multiplier port information defined in a SATA Frame Information Structure (FIS), so as to facilitate that the SATA host with usage of only one physical transport can access at most fifteen different types of flash memory cards. The SATA transmission interface can be utilized in a multi-card reader to access various types of flash memory cards and increase the transmission speed between the SATA host and the multi-card reader.

While the preferred embodiment of the present invention has been illustrated and described in details, various modifications and alterations can be made by persons skilled in this art. The embodiment of the present invention is therefore described in an illustrative but not in a restrictive sense. It is intended that the present invention should not be limited to the particular forms as illustrated, and that all modifications and alterations which maintain the spirit and realm of the present invention are within the scope as defined in the appended claims.

What is claimed is:

1. A SATA card reader control system for accessing various types of memory card data, comprising:
a status controlling register storing at least one Port Multiplier port information in consistence with a SATA transmission interface specification;
a microcontroller identifying a specific memory card type which is intended to be accessed and performing a access operation corresponding to the specific memory card type, by reading/writing the status controlling register;
an operation register storing a memory card control parameter to determine a access operation of the microcontroller;
a media hardware engine accessing the specific memory card based on the memory card control parameter; and
a data register storing a data which is accessed from the specific memory card by the media hardware engine, wherein the microcontroller identifies the specific memory card type based on the Port Multiplier port information stored in the status controlling register.

2. The SATA card reader control system of claim 1, further comprising:
a physical unit providing a signal transformation and linkage both consistent with the SATA transmission interface specification;
a link unit either decoding a data transmitted from the physical unit into a decoded data, or encoding a data into an encoded data for being transmitted to the physical unit;
a transport unit storing the decoded data transmitted from the link unit and then generating a corresponding status control parameter for storing the status control parameter to the status controlling register; and
an application unit integrating the microcontroller, the operation register, the media hardware engine and the data register, wherein the Port Multiplier port information is stored as the aforementioned status control parameter in the status controlling register.

3. The SATA card reader control system of claim 2, wherein the physical unit, the link unit, the transport unit and the application unit all are integrated as a SATA card reader chip.

4. The SATA card reader control system of claim 1, wherein the Port Multiplier port information has 4 bit.

5. The SATA card reader control system of claim 1, wherein the memory card control parameter stored in the operation register is used for controlling the access operation, a memory card power and several card reader display lights, and also for detecting a memory card plugging status.

6. The SATA card reader control system of claim 1, wherein the specific memory card type which is accessed by the media hardware engine can be a SD (Secure Digital) memory card, a Mini SD (Mini Secure Digital) memory card, a MMC (Multimedia) memory card, a CF (Compact Flash) memory card, a MS (Memory Stick) memory card or a SM (Smart Media) memory card.

7. A controlling method for a SATA card reader, comprising the following steps of:
transmitting an access instruction which contains a Port Multiplier port information indicative of a specific memory card type which is intended to be accessed;
transforming the access instruction into a digital data;
decoding the digital data into a decoded data;
identifying the specific memory card type which is intended to be accessed and performing an access operation corresponding to the memory card type, based on the Port Multiplier port information contained in the decoded data; and
transmitting a data which is accessed via a SATA transmission interface.

8. The controlling method of claim 7, wherein the Port Multiplier port information has 4 bits.

9. The controlling method of claim 7, wherein the specific memory card type which is accessed by the media hardware engine can be a SD (Secure Digital) memory card, a Mini SD (Mini Secure Digital) memory card, a MMC (Multimedia) memory card, a CF (Compact Flash) memory card, a MS (Memory Stick) memory card or a SM (Smart Media) memory card.
